(19) United States
(12) Patent Application Publication
(10) Pub. No.: US 2015/0169070 A1
(43) Pub. Date: Jun. 18, 2015

(54) Visual Display of Interactive, Gesture-Controlled, Three-Dimensional (3D) Models for Head-Mountable Displays (HMDs)

(71) Applicant: Google Inc., Mountain View, CA (US)

(72) Inventors: Andrew Logan Harp, New York City, NY (US); Sumit Jain, Santa Clara, CA (US); James Joseph Kuffner, Sunnyvale, CA (US)

(73) Assignee: Google Inc., Mountain View, CA (US)

(21) Appl. No.: 14/108,365

(22) Filed: Dec. 17, 2013

(51) Int. Cl. G06F 3/01; G02B 27/01; G06T 19/20

(52) U.S. Cl. CPC G06F 3/017; G06T 19/20; G02B 27/017; G06F 3/011; G06T 2219/2004; G06T 2219/2016; G02B 2027/0178

(57) ABSTRACT

Methods and systems are provided for controlling a three-dimensional (3D) model for a head-mountable display (HMD). The HMD can receive a 3D model for the object, where the 3D model includes three-dimensional shape and texture information about the object, the three-dimensional shape and texture information about the object specified with respect to at least a first axis, a second axis, and a third axis, where each of the first axis, the second axis, and the third axis differs. The HMD can display a view of the 3D model. The HMD can receive an input gesture. The HMD can determine whether the input gesture includes a 3D model gesture. After determining that the input gesture does includes a 3D model gesture, the HMD can update the view of the 3D model based on the input gesture and can display the updated view of the 3D model.

### BACKGROUND

In computer graphics, three-dimensional (3D) modeling involves generation of a representation of a 3D surface of an object. The representation may be referred to as a 3D object data model, or simply a 3D model, and can be rendered or displayed as a two-dimensional image via 3D rendering or displayed as a three-dimensional image. A 3D object data model may represent a 3D object using a collection of points in 3D space, connected by various geometric entities such as triangles, lines, curved surfaces, etc. Various techniques exist for generating 3D object data models utilizing point clouds and geometric shapes.

### SUMMARY

In one aspect, a method is provided. The method includes sending a 3D-model query from a head-mountable display (HMD). The 3D-model query includes information about an object. The HMD receives a 3D model for the object. The 3D model includes three-dimensional shape and texture information about the object. The HMD displays a view of the 3D model. The HMD receives an input gesture. It is determined whether the input gesture is related to the 3D model. After determining that the input gesture is related to the 3D model, the HMD updates the view of the 3D model based on the input gesture and displays the updated view of the 3D model.

In another aspect, an HMD is provided. The HMD includes a display, a processor, and a non-transitory computer readable medium. The non-transitory computer readable medium is configured to store at least instructions. The instructions are executable by the processor to cause the HMD to perform functions including: receiving a 3D model for an object, where the 3D model includes three-dimensional shape and texture information about the object, the three-dimensional shape and texture information about the object specified with respect to at least a first axis, a second axis, and a third axis, where each of the first axis, the second axis, and the third axis differs; displaying a view of the 3D model using the display; receiving an input gesture; determining whether the input gesture includes a 3D-model gesture of a plurality of 3D-model gestures, where the plurality of 3D-model gestures include a first 3D-model gesture to modify display of the 3D model with respect to the first axis, a second 3D-model gesture to modify display of the 3D model with respect to the second axis, and a third 3D-model gesture to modify display of the 3D model with respect to the third axis; and after determining that the input gesture is related to the 3D model: updating the view of the 3D model based on the input gesture, and displaying the updated view of the 3D model using the display.

In yet another aspect, a non-transitory computer readable medium is provided. The non-transitory computer readable medium has stored therein instructions executable by a processor of a head-mountable display (HMD) to cause the HMD to perform functions. The functions include: receiving a 3D model for an object, where the 3D model includes three-dimensional shape and texture information about the object, the three-dimensional shape and texture information about the object specified with respect to at least a first axis, a second axis, and a third axis, where each of the first axis, the second axis, and the third axis differs; displaying a view of the 3D model; receiving an input gesture; determining whether the input gesture includes a 3D-model gesture of a plurality of 3D-model gestures, where the plurality of 3D-model gestures include a first 3D-model gesture to modify display of the 3D model with respect to the first axis, a second 3D-model gesture to modify display of the 3D model with respect to the second axis, and a third 3D-model gesture to modify display of the 3D model with respect to the third axis; and after determining that the input gesture is related to the 3D model: updating the view of the 3D model based on the input gesture, and displaying the updated view of the 3D model.

In even another aspect, a HMD is provided. The HMD includes: means for receiving a 3D model for an object, where the 3D model includes three-dimensional shape and texture information about the object, the three-dimensional shape and texture information about the object specified with respect to at least a first axis, a second axis, and a third axis, where each of the first axis, the second axis, and the third axis differs; means for displaying a view of the 3D model; means for receiving an input gesture; means for determining whether the input gesture includes a 3D-model gesture of a plurality of 3D-model gestures, where the plurality of 3D-model gestures include a first 3D-model gesture to modify display of the 3D model with respect to the first axis, a second 3D-model gesture to modify display of the 3D model with respect to the second axis, and a third 3D-model gesture to modify display of the 3D model with respect to the third axis; and means for, after determining that the input gesture is related to the 3D model: updating the view of the 3D model based on the input gesture, and displaying the updated view of the 3D model.

### BRIEF DESCRIPTION OF THE DRAWINGS

FIG. 1 is a flowchart of a method, in accordance with an example embodiment.

FIG. 2A illustrates a HMD according to an example embodiment.

FIG. 2B illustrates an alternate view of the HMD illustrated in FIG. 2A.

FIG. 2C illustrates another HMD according to an example embodiment.

FIG. 2D illustrates another HMD according to an example embodiment.

FIGS. 2E to 2G are simplified illustrations of the HMD shown in FIG. 2D, being worn by a wearer.

FIG. 3 is a block diagram of an HMD, in accordance with an example embodiment.

FIG. 4A depicts a scenario of displaying a 3D model obtained in response to a 3D-model query, in accordance with an example embodiment.

FIG. 4B depicts a variation of the scenario of FIG. 4A for displaying a 3D model in an environment, in accordance with an example embodiment.

FIG. 4C depicts another variation of the scenario of FIG. 4A for displaying a 3D model in an environment, in accordance with an example embodiment.

FIGS. 5A and 5B are charts of images captured over time with corresponding motions and gestures, in accordance with an example embodiment.

FIG. 6 shows input gestures and corresponding changes to a 3D model, in accordance with an example embodiment.

FIG. 7 depicts a distributed computing architecture, in accordance with an example embodiment.

FIG. 8A is a block diagram of a computing device, in accordance with an example embodiment.

FIG. 8B depicts a cloud-based server system, in accordance with an example embodiment.

### DETAILED DESCRIPTION

Overview

Example embodiments disclosed herein relate to requesting delivery of a 3D model using a query that includes image information and to controlling display of a 3D model using gesture inputs. Some devices, such as some implementations of HMDs, have limited input mechanisms. For example, some HMDs may not include a keyboard or other touch-based interface. Then, textual input can be difficult using these HMDs. Therefore, other inputs, such as images, video, and/or spoken inputs can be used to generate search queries, such as queries for 3D models. For example, a wearer of an HMD can capture one or more image(s) and/or video of an object. Then, the HMD can formulate a query for a 3D model including the image(s) and/or video and provide the query to a 3D-model server. In response to the query, the 3D-model server can use the image(s) and/or video to identify the object, locate one or more 3D models of the object, and deliver some or all of the 3D models to the HMD.

Once the HMD receives the 3D model(s), the HMD can generate a display of the 3D model(s). To interact with the 3D model, the HMD can capture images of the wearer's hands (or other objects) making gestures, perhaps using the same camera used to capture image(s) of the object. The images can be processed to determine hand motions and corresponding gestures. The gestures can be interpreted by the HMD as commands for interacting with the 3D model(s). As such, the wearer can interact with the 3D model(s) by making gestures. For example, a wearer can move their hand in a vertical line downward to command the HMD to move the 3D model downward. As another example, the wearer can move their hand in a clockwise circular motion to command the HMD to rotate the 3D model clockwise.

The herein-disclosed techniques can use a combination of cloud-based model servers and HMDs to request, render, and control 3D models using images as inputs to query for 3D models and to control rendering of the 3D models using hand gestures. By taking advantage of these rich interaction modalities, it is possible to avoid interactions through bandwidth limited input mechanisms. For example, using an HMD to find a 3D model of an object based on an input image can be accomplished much easier and faster than trying to input the appropriate text using the HMD. Additionally, manipulating the rendered model with hand movements should be more natural and intuitive than using other input devices due to an implied physical presence of the virtual object. Thus, the herein-described techniques for obtaining, displaying, and interacting with information about objects, such as 3D models of the objects, can speed and simply wearer interactions with an HMD.

Example Operations

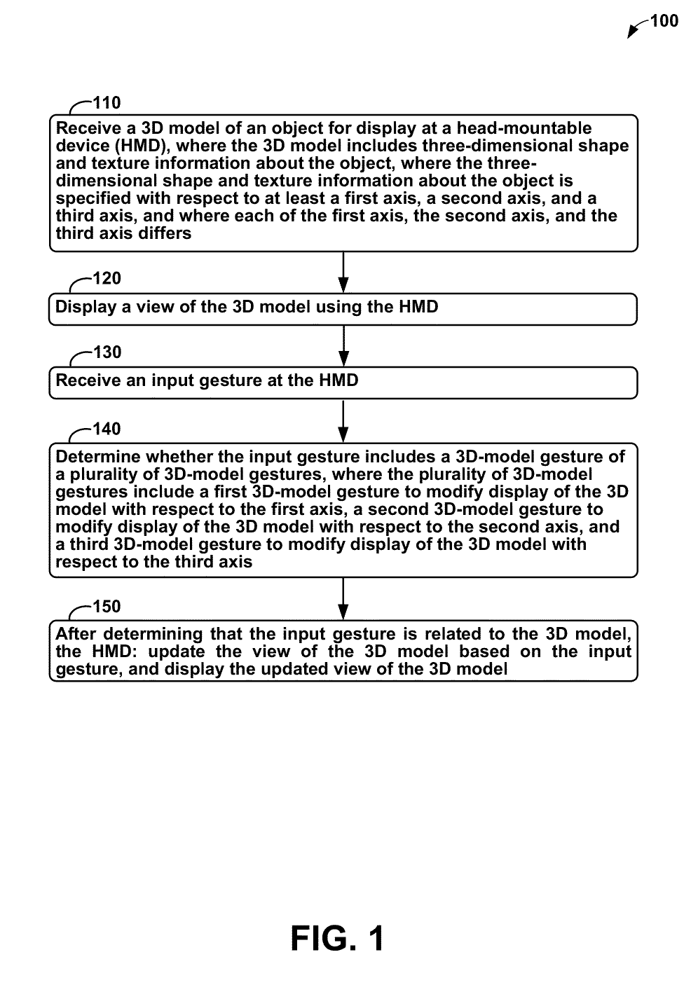

FIG. 1 is a flowchart of method 100, in accordance with an example embodiment. Method 100 can be carried out by a HMD, such as HMD 272 discussed below. In some embodiments, method 100 can be carried out by a computing device acting as an HMD, such as computing device 800 discussed below.

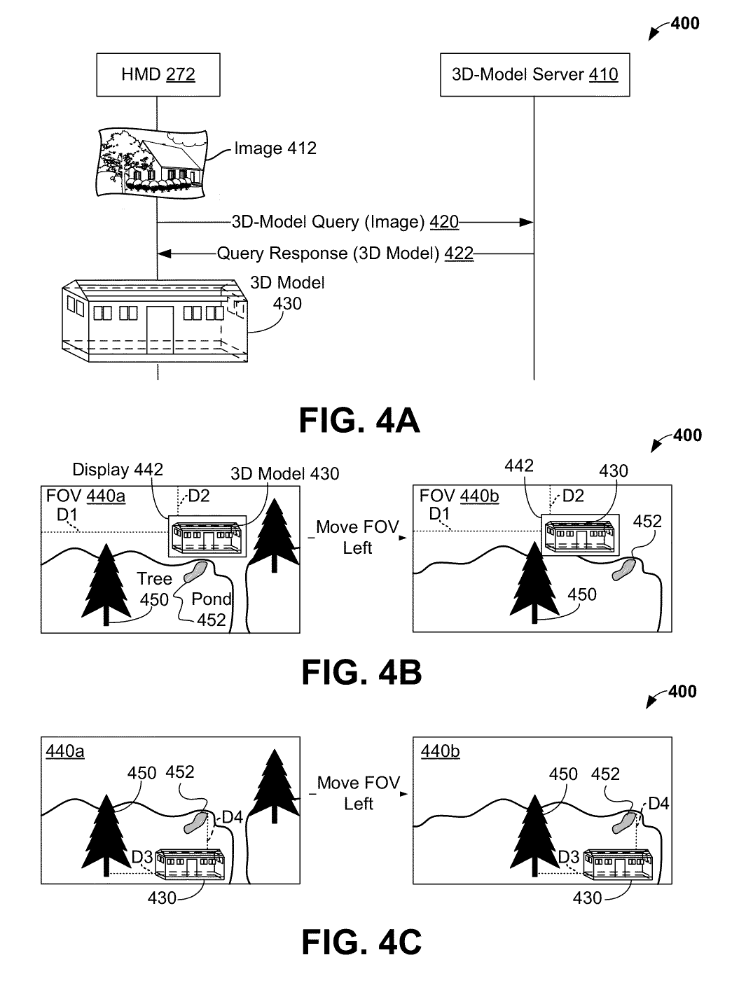

Method 100 can begin at block 110, where a HMD can receive a 3D model for an object. The 3D model can include three-dimensional shape and texture information about the object, the three-dimensional shape and texture information about the object specified with respect to at least a first axis, a second axis, and a third axis, where each of the first axis, the second axis, and the third axis differs, such as discussed below in the context of at least FIG. 4A. In some embodiments, the information about the object can include an image related to the object. In particular embodiments, the image related to the object can be at least one image selected from the group consisting of an image that depicts at least part of the object, an image of a Quick Response (QR) code related to the object, and an image of a bar code related to the object.

At block 120, the HMD can display a view of the 3D model, such as discussed below in the context of at least FIG. 4A.

At block 130, the HMD can receive an input gesture, such as discussed below in the context of at least FIGS. 4B, 4C, 5A, 5B, and 6. In some embodiments, the input gesture can include a gesture to rotate the 3D model. In particular embodiments, the gesture to rotate the 3D model can include a first gesture to rotate the 3D model on a first axis and a second gesture to rotate the 3D model on a second axis, and wherein the first axis differs from the second axis.

At block 140, it can be determined whether the input gesture includes a 3D-model gesture of a plurality of 3D-model gestures, where the plurality of 3D-model gestures includes a first 3D-model gesture to modify display of the 3D model with respect to the first axis, a second 3D-model gesture to modify display of the 3D model with respect to the second axis, and a third 3D-model gesture to modify display of the 3D model with respect to the third axis, such as discussed below in the context of at least FIGS. 4B, 4C, 5A, 5B, and 6. In some embodiments, the HMD can determine whether the input gesture is related to the 3D model. In particular embodiments, the HMD can determine whether the input gesture is related to the 3D model without communicating with another computing device; i.e., the HMD can determine whether the input gesture is related to the 3D model as a standalone device. In other particular embodiments, the HMD can determine whether the input gesture is related to the 3D model via communication with another computing device; e.g., the HMD can provide data related to the input gesture, such as video or image data, to an gesture server or other computing device, and in response, the gesture server can inform the HMD whether the input gesture is related to the 3D model so that the HMD can determine whether the input gesture is related to the 3D model.

At block 150, after determining that the input gesture is related to the 3D model, the HMD can update the view of the 3D model based on the input gesture and display the updated view of the 3D model. In some embodiments where the input gesture includes a gesture to rotate the 3D model, updating the view of the 3D model can include: rotating the 3D model as indicated by the gesture to rotate the 3D model and generating a display of the rotated 3D model.

In some embodiments, method 100 can further include: receiving a second input gesture at the HMD, determining whether the second input gesture corresponds to a close gesture, and in response to determining that the second input gesture corresponds to the close gesture, terminating the view of the 3D model.

Example Head-Mountable Displays

Systems and devices in which example embodiments may be implemented will now be described in greater detail. In general, an example system may be implemented in or may take the form of a wearable computer (also referred to as a wearable computing device). In an example embodiment, a wearable computer takes the form of or includes a head-mountable display (HMD).

An example system may also be implemented in or take the form of other devices, such as a mobile phone, among other possibilities. Further, an example system may take the form of a non-transitory computer readable medium, which has program instructions stored thereon that are executable by at a processor to provide the functionality described herein. An example system may also take the form of a device such as a wearable computer or mobile phone, or a subsystem of such a device, which includes such a non-transitory computer readable medium having such program instructions stored thereon.

An HMD may generally be any display device that is capable of being worn on the head and places a display in front of one or both eyes of the wearer. An HMD may take various forms such as a helmet or eyeglasses. As such, references to “eyeglasses” or a “glasses-style” HMD should be understood to refer to an HMD that has a glasses-like frame so that it can be worn on the head. Further, example embodiments may be implemented by or in association with an HMD with a single display or with two displays, which may be referred to as a “monocular” HMD or a “binocular” HMD, respectively.

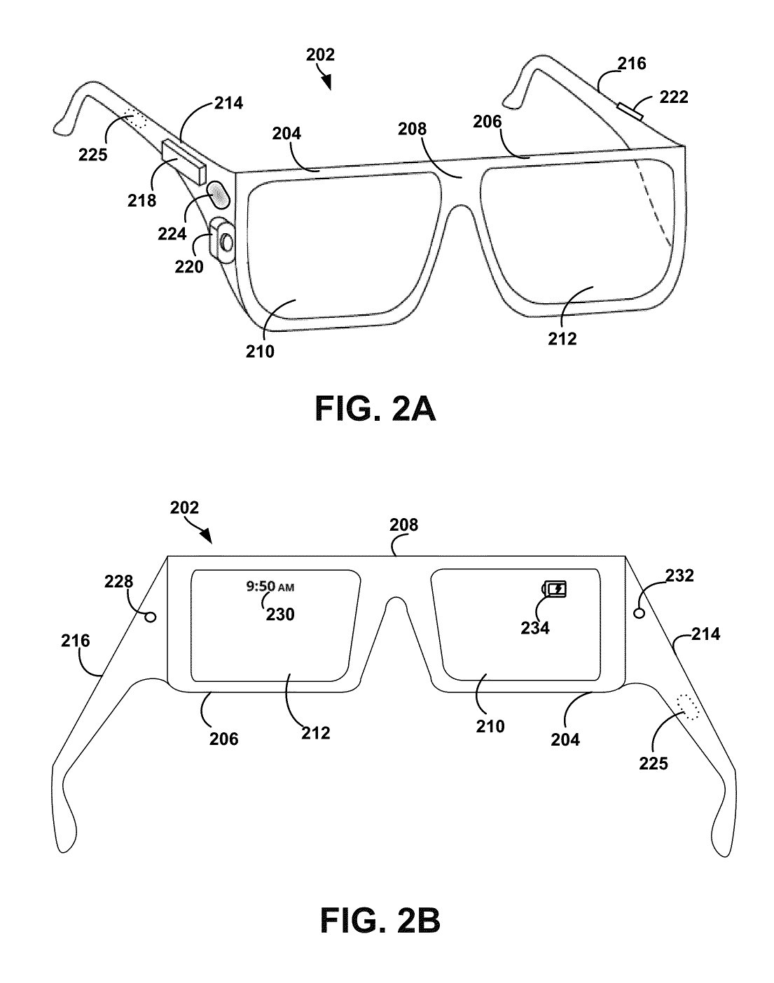

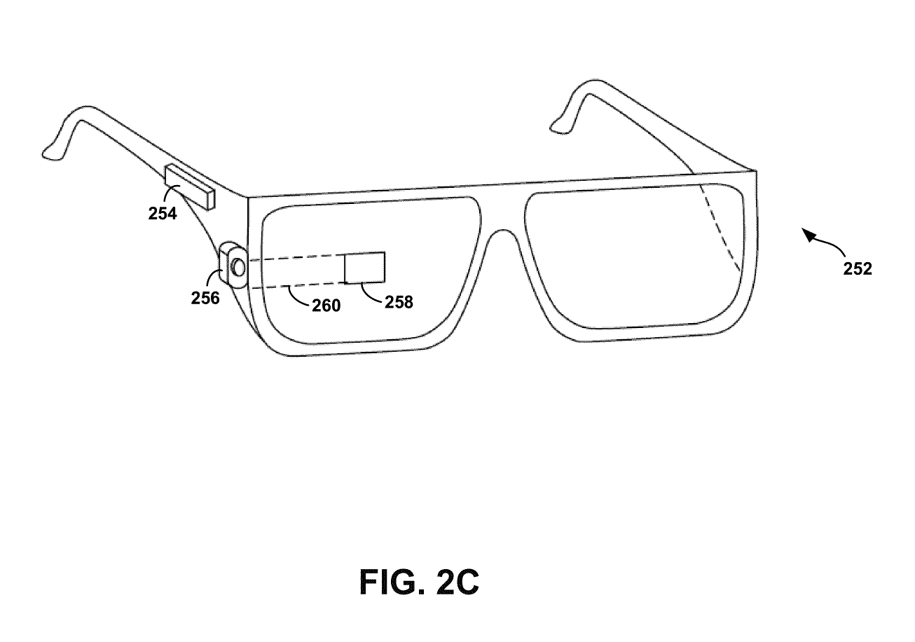

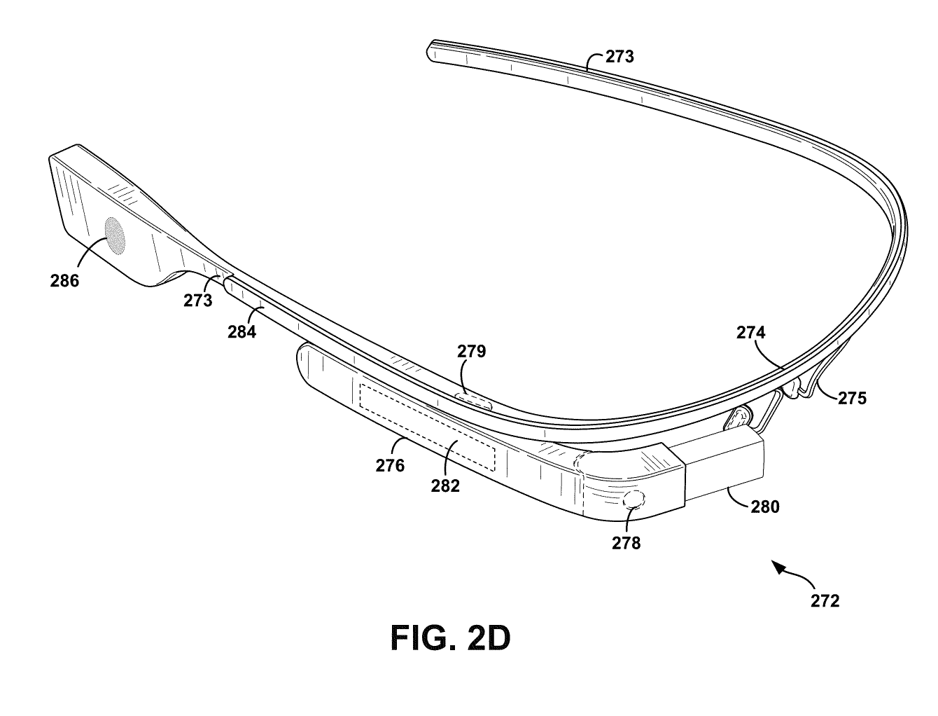

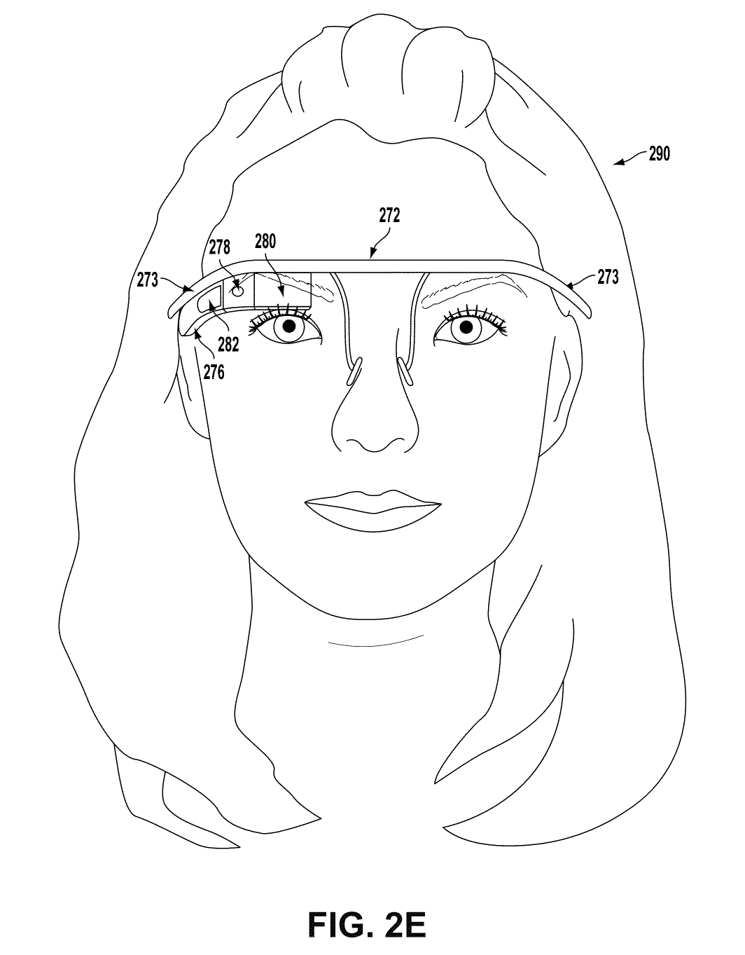

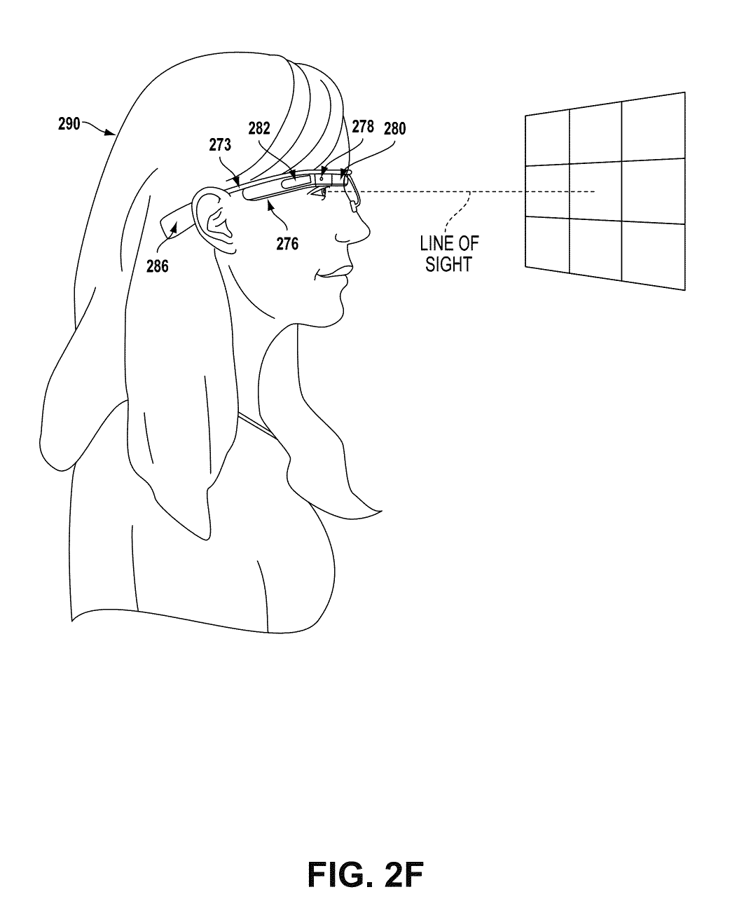

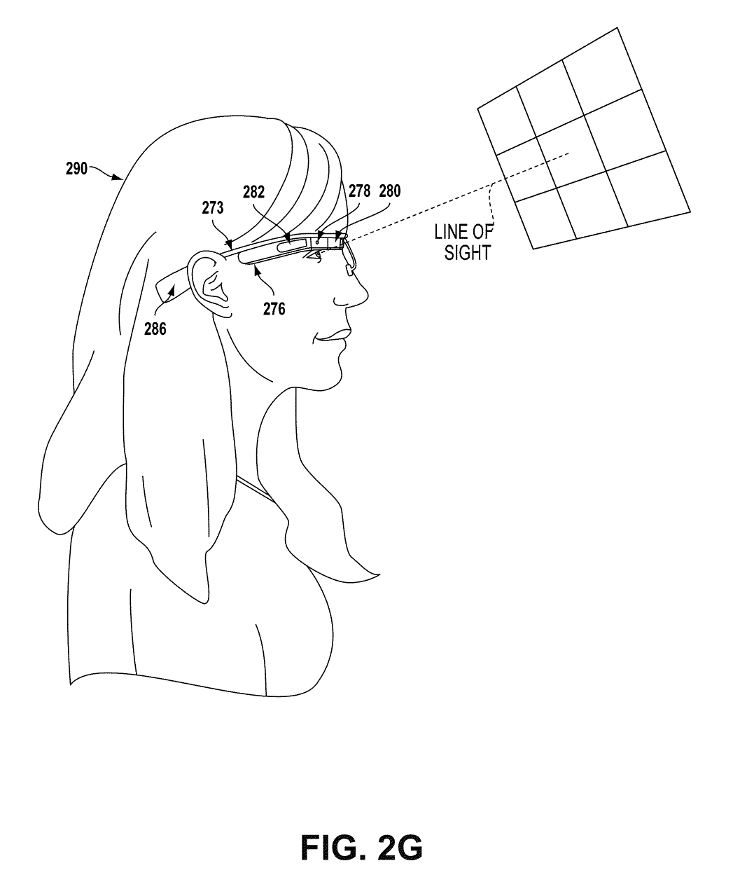

FIG. 2A illustrates a wearable computing system according to an example embodiment. In FIG. 2A, the wearable computing system takes the form of HMD 202. It should be understood, however, that example systems and devices may take the form of or be implemented within or in association with other types of devices, without departing from the scope of the invention.

As illustrated in FIG. 2A, the HMD 202 includes frame elements including lens-frames 204, 206 and a center frame support 208, lens elements 210, 212, and extending side-arms 214, 216. The center frame support 208 and the extending side-arms 214, 216 are configured to secure HMD 202 to a user's face via a user's nose and ears, respectively.

Each of the frame elements 204, 206, and 208 and the extending side-arms 214, 216 may be formed of a solid structure of plastic and/or metal, or may be formed of a hollow structure of similar material so as to allow wiring and component interconnects to be internally routed through HMD 202. Other materials may be possible as well.

One or more of each of the lens elements 210, 212 may be formed of any material that can suitably display a projected image or graphic. Each of the lens elements 210, 212 may also be sufficiently transparent to allow a user to see through the lens element. Combining these two features of the lens elements may facilitate an augmented reality or heads-up display where the projected image or graphic is superimposed over a real-world view as perceived by the user through the lens elements.

The extending side-arms 214, 216 may each be projections that extend away from the lens-frames 204, 206, respectively, and may be positioned behind a user's ears to secure the HMD 202 to the user. The extending side-arms 214, 216 may further secure the HMD 202 to the user by extending around a rear portion of the user's head. Additionally or alternatively, for example, the HMD 202 may connect to or be affixed within a head-mounted helmet structure. Other configurations for an HMD are also possible.

The HMD 202 may also include an on-board computing system 218, an image capture device 220, a sensor 222, and a finger-operable touch pad 224. The on-board computing system 218 is shown to be positioned on the extending side-arm 214 of the HMD 202; however, the on-board computing system 218 may be provided on other parts of the HMD 202 or may be positioned remote from the HMD 202 (e.g., the on-board computing system 218 could be wire- or wirelessly-connected to the HMD 202). The on-board computing system 218 may include a processor and memory, for example. The on-board computing system 218 may be configured to receive and analyze data from the image capture device 220 and the finger-operable touch pad 224 (and possibly from other sensory devices, user interfaces, or both) and generate images for output by the lens elements 210 and 212.

The image capture device 220 may be, for example, a camera that is configured to capture still images and/or video. In the illustrated configuration, image capture device 220 is positioned on the extending side-arm 214 of the HMD 202; however, the image capture device 220 may be provided on other parts of the HMD 202. The image capture device 220 may be configured to capture images at various resolutions or at different frame rates. Many image capture devices with a small form-factor, such as the cameras used in mobile phones or webcams, for example, may be incorporated into an example of the HMD 202.

Further, although FIG. 2A illustrates one image capture device 220, more than one image capture device may be used, and each may be configured to capture the same view, or to capture different views. For example, the image capture device 220 may be forward facing to capture at least a portion of the real-world view perceived by the user. This forward facing image captured by the image capture device 220 may then be used to generate an augmented reality where computer generated images appear to interact with or overlay the real-world view perceived by the user.

The sensor 222 is shown on the extending side-arm 216 of the HMD 202; however, the sensor 222 may be positioned on other parts of the HMD 202. For illustrative purposes, only one sensor 222 is shown. However, in an example embodiment, the HMD 202 may include multiple sensors. For example, an HMD 202 may include sensors 222 such as one or more gyroscopes, one or more accelerometers, one or more magnetometers, one or more light sensors, one or more infrared sensors, and/or one or more microphones. Other sensing devices may be included in addition or in the alternative to the sensors that are specifically identified herein.

The finger-operable touch pad 224 is shown on the extending side-arm 214 of the HMD 202. However, the finger-operable touch pad 224 may be positioned on other parts of the HMD 202. Also, more than one finger-operable touch pad may be present on the HMD 202. The finger-operable touch pad 224 may be used by a user to input commands. The finger-operable touch pad 224 may sense at least one of a pressure, position and/or a movement of one or more fingers via capacitive sensing, resistance sensing, or a surface acoustic wave process, among other possibilities. The finger-operable touch pad 224 may be capable of sensing movement of one or more fingers simultaneously, in addition to sensing movement in a direction parallel or planar to the pad surface, in a direction normal to the pad surface, or both, and may also be capable of sensing a level of pressure applied to the touch pad surface. In some embodiments, the finger-operable touch pad 224 may be formed of one or more translucent or transparent insulating layers and one or more translucent or transparent conducting layers. Edges of the finger-operable touch pad 224 may be formed to have a raised, indented, or roughened surface, so as to provide tactile feedback to a user when the user's finger reaches the edge, or other area, of the finger-operable touch pad 224. If more than one finger-operable touch pad is present, each finger-operable touch pad may be operated independently, and may provide a different function.

In a further aspect, HMD 202 may be configured to receive user input in various ways, in addition or in the alternative to user input received via finger-operable touch pad 224. For example, on-board computing system 218 may implement a speech-to-text process and utilize a syntax that maps certain spoken commands to certain actions. In addition, HMD 202 may include one or more microphones via which a wearer's speech may be captured. Configured as such, HMD 202 may be operable to detect spoken commands and carry out various computing functions that correspond to the spoken commands.

As another example, HMD 202 may interpret certain head-movements as user input. For example, when HMD 202 is worn, HMD 202 may use one or more gyroscopes and/or one or more accelerometers to detect head movement. The HMD 202 may then interpret certain head movements as being user input, such as nodding, or looking up, down, left, or right. HMD 202 could also pan or scroll through graphics in a display according to movement. Other types of actions may also be mapped to head movement.

As yet another example, HMD 202 may interpret certain gestures (e.g., by a wearer's hand or hands) as user input such as describe herein. For example, HMD 202 may capture hand movements by analyzing image data from image capture device 220, and initiate actions that are defined as corresponding to certain hand movements.

As a further example, HMD 202 may interpret eye movement as user input. In particular, HMD 202 may include one or more inward-facing image capture devices and/or one or more other inward-facing sensors (not shown) sense a user's eye movements and/or positioning. As such, certain eye movements may be mapped to certain actions. For example, certain actions may be defined as corresponding to movement of the eye in a certain direction, a blink, and/or a wink, among other possibilities.

HMD 202 can include a speaker 225 for generating audio output. In one example, the speaker could be in the form of a bone conduction speaker, also referred to as a bone conduction transducer (BCT). Speaker 225 may be, for example, a vibration transducer or an electroacoustic transducer that produces sound in response to an electrical audio signal input. The frame of HMD 202 may be designed such that when a wearer wears HMD 202, speaker 225 contacts the wearer. Alternatively, speaker 225 may be embedded within the frame of HMD 202 and positioned such that, when the HMD 202 is worn, speaker 225 vibrates a portion of the frame that contacts the wearer. In either case, HMD 202 may be configured to send an audio signal to speaker 225, so that vibration of the speaker may be directly or indirectly transferred to the bone structure of the wearer. When the vibrations travel through the bone structure to the bones in the middle ear of the wearer, the wearer can interpret the vibrations provided by BCT 225 as sounds.

Various types of bone-conduction transducers (BCTs) may be implemented, depending upon the particular implementation. Generally, any component that is arranged to vibrate the HMD 202 may be incorporated as a vibration transducer. Yet further it should be understood that an HMD 202 may include a single speaker 225 or multiple speakers. In addition, the location(s) of speaker(s) on the HMD may vary, depending upon the implementation. For example, a speaker may be located proximate to a wearer's temple (as shown), behind the wearer's ear, proximate to the wearer's nose, and/or at any other location where the speaker 225 can vibrate the wearer's bone structure.

FIG. 2B illustrates an alternate view of the wearable computing device illustrated in FIG. 2A. As shown in FIG. 2B, the lens elements 210, 212 may act as display elements. The HMD 202 may include a first projector 228 coupled to an inside surface of the extending side-arm 216 and configured to project a display 230 onto an inside surface of the lens element 212. Additionally or alternatively, a second projector 232 may be coupled to an inside surface of the extending side-arm 214 and configured to project a display 234 onto an inside surface of the lens element 210.

The lens elements 210, 212 may act as a combiner in a light projection system and may include a coating that reflects the light projected onto them from the projectors 228, 232. In some embodiments, a reflective coating may not be used (e.g., when the projectors 228, 232 are scanning laser devices). In alternative embodiments, other types of display elements may also be used. For example, the lens elements 210, 212 themselves may include: a transparent or semi-transparent matrix display, such as an electroluminescent display or a liquid crystal display, one or more waveguides for delivering an image to the user's eyes, or other optical elements capable of delivering an in focus near-to-eye image to the user. A corresponding display driver may be disposed within the frame elements 204, 206 for driving such a matrix display. Alternatively or additionally, a laser or LED source and scanning system could be used to draw a raster display directly onto the retina of one or more of the user's eyes. Other possibilities exist as well.

FIG. 2C illustrates another wearable computing system according to an example embodiment, which takes the form of an HMD 252. The HMD 252 may include some or all of the elements of HMD 202 described with respect to FIGS. 2A and 2B. The HMD 252 may additionally include an on-board computing system 254 and an image capture device 256, as detailed above with respect to FIGS. 2A and 2B. The image capture device 256 is shown mounted on a frame of the HMD 252. However, the image capture device 256 may be mounted at other positions as well.

As shown in FIG. 2C, the HMD 252 may include a single display 258 which may be coupled to the device. The display 258 may be formed on one of the lens elements of the HMD 252, such as a lens element described with respect to FIGS. 2A and 2B, and may be configured to overlay computer-generated graphics in the user's view of the physical world. The display 258 is shown to be provided in a center of a lens of the HMD 252, however, the display 258 may be provided in other positions, such as for example towards either the upper or lower portions of the wearer's field of view. The display 258 is controllable via the computing system 254 that is coupled to the display 258 via an optical waveguide 260.

FIG. 2D illustrates another wearable computing system according to an example embodiment, which takes the form of a monocular HMD 272. HMD 272 can include some or all of the elements of HMD 202 and/or HMD 252, described above in the context of FIGS. 2A, 2B, and 2C. The HMD 272 may include side-arms 273, a center frame support 274, and a bridge portion with nosepiece 275. In the example shown in FIG. 2D, the center frame support 274 connects the side-arms 273. The HMD 272 does not include lens-frames containing lens elements. The HMD 272 may additionally include a component housing 276, which may include an on-board computing system (not shown), an image capture device 278, and a button 279 for operating the image capture device 278 (and/or usable for other purposes). Component housing 276 may also include other electrical components and/or may be electrically connected to electrical components at other locations within or on the HMD. HMD 272 can include a speaker, such as BCT 286.

HMD 272 may include a single display 280, which may be coupled to one of the side-arms 273 via the component housing 276. In an example embodiment, the display 280 may be a see-through display, which is made of glass and/or another transparent or translucent material, such that the wearer can see their environment through the display 280. Further, the component housing 276 may include the light sources (not shown) for the display 280 and/or optical elements (not shown) to direct light from the light sources to the display 280. As such, display 280 may include optical features that direct light that is generated by such light sources towards the wearer's eye, when HMD 272 is being worn. In a further aspect, HMD 272 may include a sliding feature 284, which may be used to adjust the length of the side-arms 273. Thus, sliding feature 284 may be used to adjust the fit of HMD 272. Further, an HMD may include other features that allow a wearer to adjust the fit of the HMD, without departing from the scope of the invention.

FIGS. 2E to 2G are simplified illustrations of the HMD 272 shown in FIG. 2D, being worn by a wearer 290. As shown in FIG. 2F, when HMD 272 is worn, BCT 286 is arranged such that when HMD 272 is worn, BCT 286 is located behind the wearer's ear. As such, BCT 286 is not visible from the perspective shown in FIG. 2E.

In the illustrated example, the display 280 may be arranged such that when HMD 272 is worn, display 280 is positioned in front of or proximate to a user's eye when the HMD 272 is worn by a user. For example, display 280 may be positioned below the center frame support and above the center of the wearer's eye, as shown in FIG. 2E. Further, in the illustrated configuration, display 280 may be offset from the center of the wearer's eye (e.g., so that the center of display 280 is positioned to the right and above of the center of the wearer's eye, from the wearer's perspective).

Configured as shown in FIGS. 2E to 2G, display 280 may be located in the periphery of the field of view of the wearer 290, when HMD 272 is worn. Thus, as shown by FIG. 2F, when the wearer 290 looks forward, the wearer 290 may see the display 280 with their peripheral vision. As a result, display 280 may be outside the central portion of the wearer's field of view when their eye is facing forward, as it commonly is for many day-to-day activities. Such positioning can facilitate unobstructed eye-to-eye conversations with others, as well as generally providing unobstructed viewing and perception of the world within the central portion of the wearer's field of view. Further, when the display 280 is located as shown, the wearer 290 may view the display 280 by, e.g., looking up with their eyes only (possibly without moving their head). This is illustrated as shown in FIG. 2G, where the wearer has moved their eyes to look up and align their line of sight with display 280. A wearer might also use the display by tilting their head down and aligning their eye with the display 280.

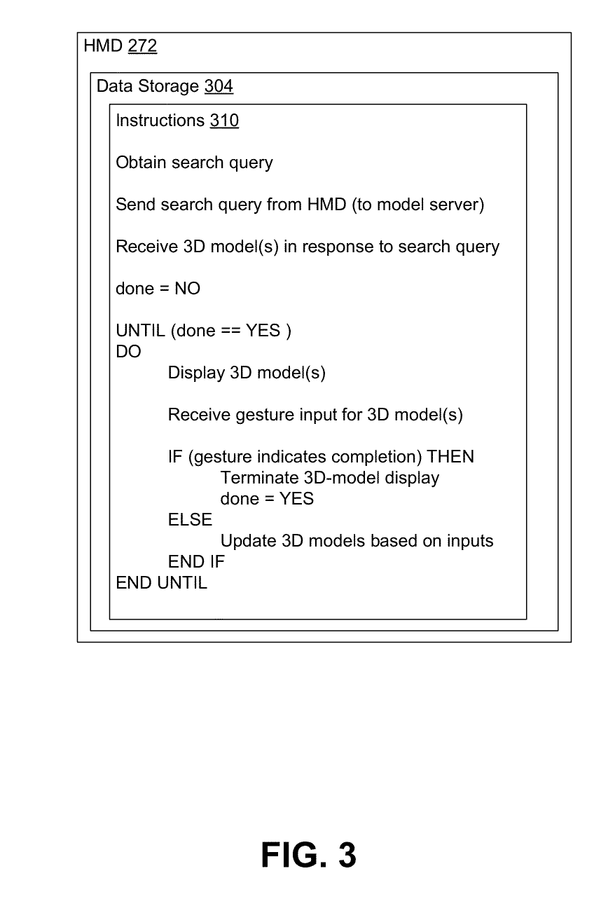

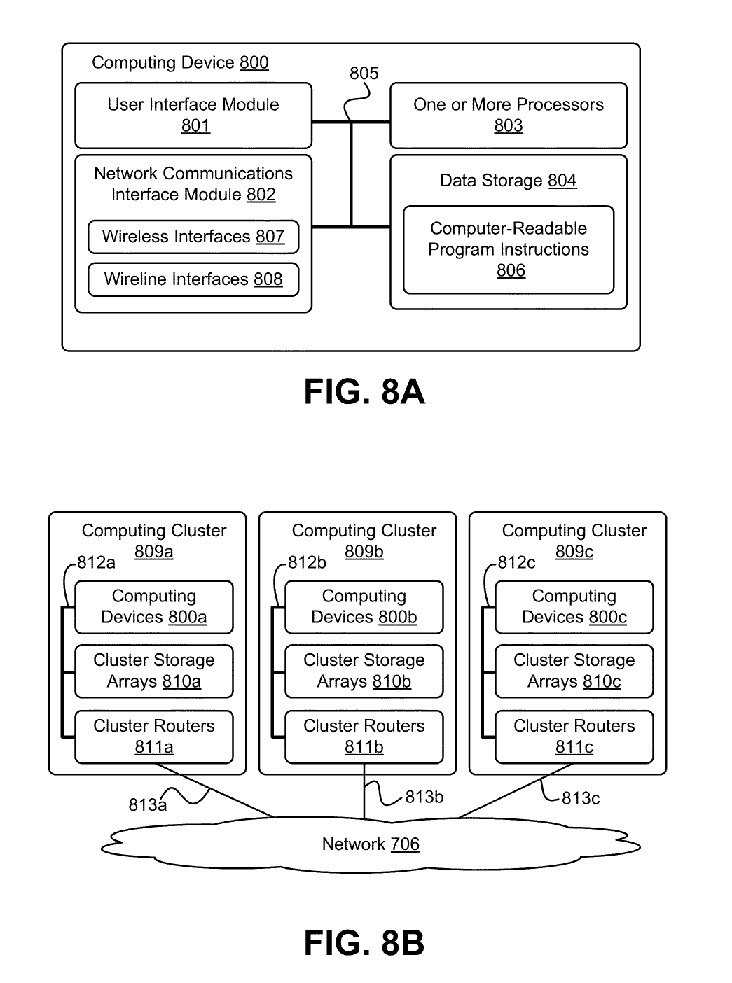

FIG. 3 is a block diagram of HMD 272, in accordance with an example embodiment. HMD 272 can include data storage 304, where data storage 304 is configured to store at least instructions 310. For example, HMD 272 can be a computing device such as computing device 800 discussed below at least in the context of FIG. 8A, and instructions 310 can be stored in data storage 304, such as data storage 804 discussed below at least in the context of FIG. 8A. Instructions 310 can be instructions such as computer-readable program instructions 806 discussed below at least in the context of FIG. 8A. In other embodiments, instructions 310 can be utilized in other computing devices than HMDs, such as, but not limited to, a telephone/smart phone, a laptop, a desktop, a server, and/or another type of wearable computing device.

Instructions 310 when executed by one or processors of HMD 272 can perform one or more functions. For example, the one or more processors of HMD 272 can be processors 803 discussed below in the context of computing device 800.

The functions can include obtaining a 3D-model query, perhaps via a user interface of HMD 272. The 3D-model query can include information related to an object. The object can be any object that may have a 3D model, even objects that may be primarily in less than three dimensions; e.g., a piece of paper, a human hair, an object not visible to the human eye. The information can include text, one or more still images, video information, audio information, binary information, other information, and combinations thereof. To provide this information, HMD 272 can be configured with input devices, such as text-input devices, image capture devices (e.g., one or more still and/or video cameras), audio capture devices (e.g., one or more microphones).

For example, HMD 272 can have a camera configured to capture images related to the object, such as images of part or all of the object and/or images otherwise related to the object, such as, but not limited to, images of Quick Response (QR) codes, bar codes, advertisements, location information, catalog information, ordering information, and information about an environment of the object. HMD 272 can provide the images, and perhaps other information such as text related to the object or images, in the 3D-model query for the object. HMD 272 can obtain the 3D-model query by generating the 3D-model query, formatting the 3D-model query, and/or otherwise gathering the 3D-model query.

Once obtained, HMD 272 can send the 3D-model query to a model server, such as 3D-model server 410 discussed below in the context of at least FIG. 4A. The model server can use the information in the 3D-model query to locate a 3D model of the object and provide the 3D model to HMD 272. In other embodiments, the model server can provide HMD 272 with a reference to the 3D model; in these embodiments, the model server can render the 3D model and perhaps update the 3D model rendering based on commands provided by HMD 272 related to the 3D model, such as the commands based on gestures discloses herein.

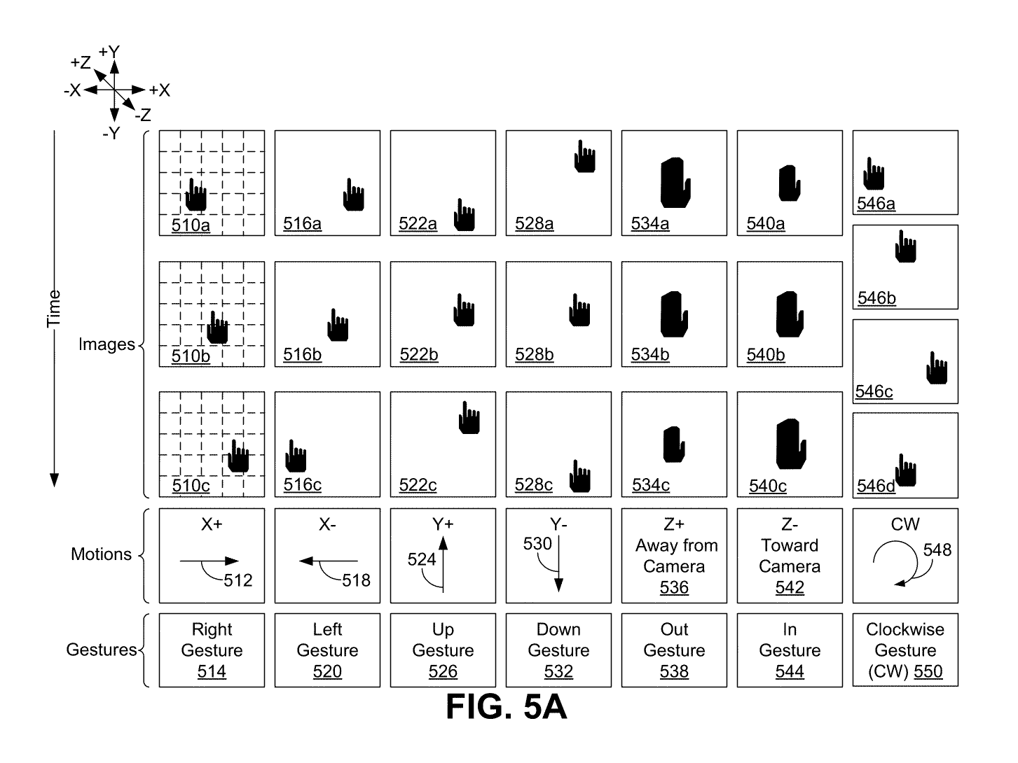

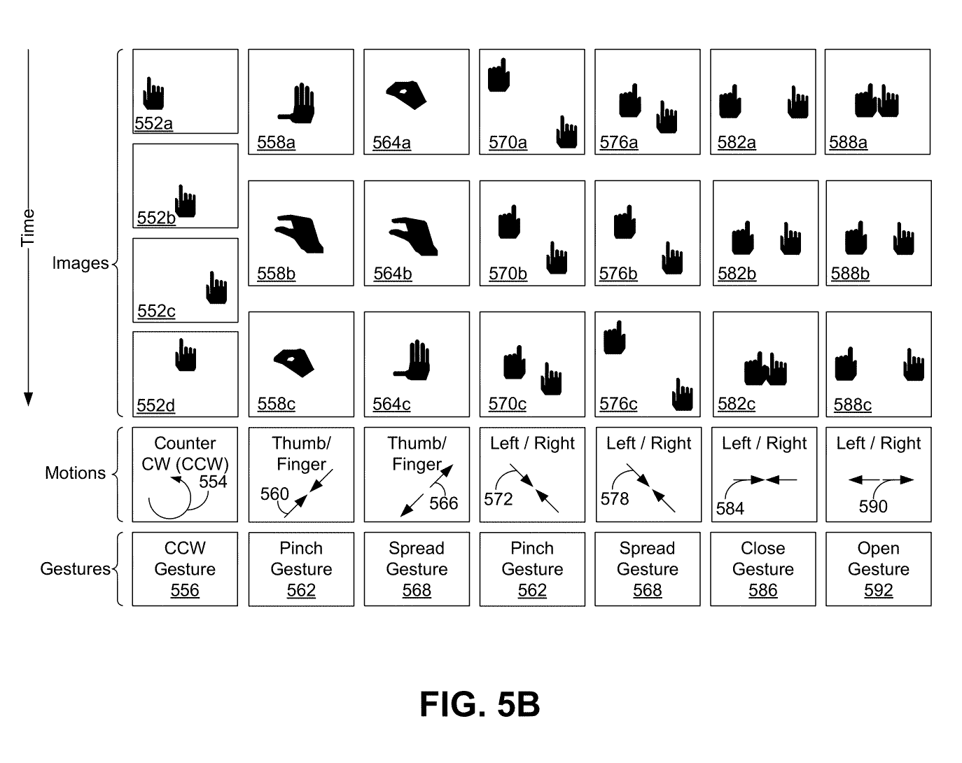

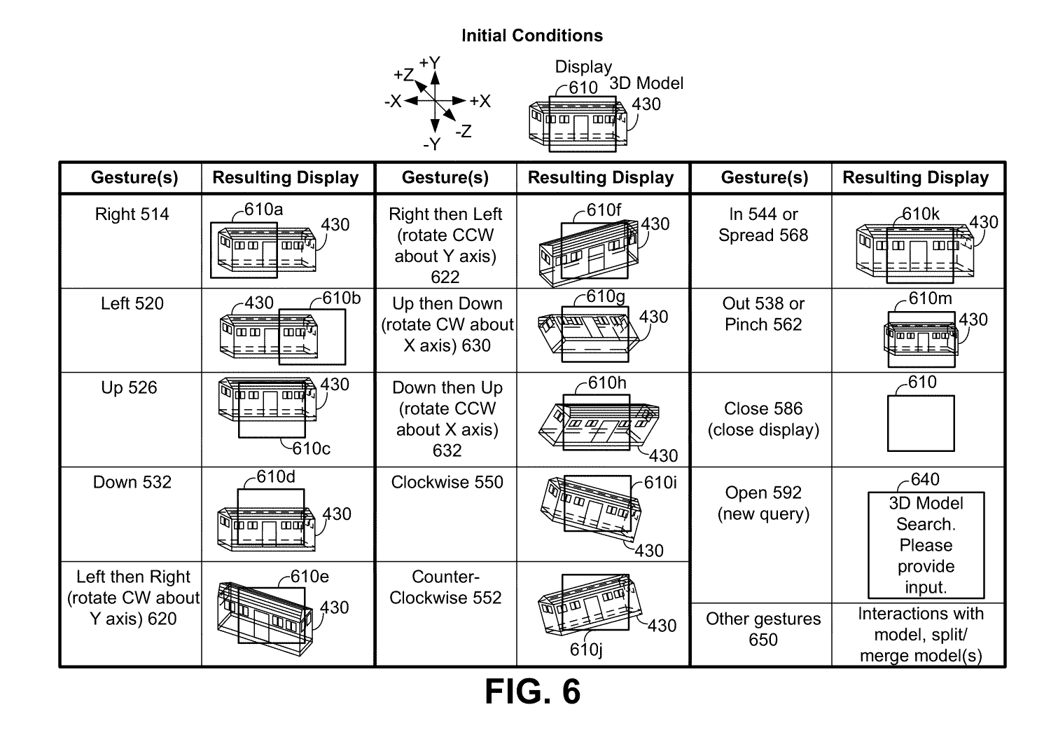

After receiving the 3D model, HMD 272 can generate a display of a view of the 3D model and display the view of the 3D model. After the view of the 3D model has been displayed, a wearer of the HMD 272 can make gestures and/or provide other inputs related to the model. The other inputs can include, but are not limited to, voice inputs, text inputs, other image-based inputs, and inputs provided by a user interface, such as a Graphical User Interface (GUI) of HMD 272 and/or other computing device(s). Example gestures are discussed below in more detail at least in the context of FIGS. 5A, 5B, and 6.

For example, the wearer of the HMD 272 can make a gesture to rotate the 3D model. HMD 272 can capture one or more images of the wearer making the rotation gesture. The images of the gesture can be processed; e.g., by HMD 272, model server 410, and/or other computing devices, to determine a corresponding command to change a model view of the 3D model; in this example, to rotate the 3D model. Once a rotation command is available, HMD 272 can update the display of the 3D model in response; in this example, HMD 272 can rotate the 3D model, update the view of the 3D model to show the rotated 3D model, and display the updated view of the 3D model.

One gesture (or other input) can be a close gesture (or corresponding other input) intended to terminate the view of the 3D model. Upon determining that the wearer made the close gesture (or corresponding other input), an end-display command to end the view of the 3D model can be provided to HMD 272. Upon receiving the end-display command, HMD 272 can indicate that the view of the 3D model is terminated; e.g., using appropriate data, such as the done variable shown in FIG. 3, and consequently terminate the view of the 3D model.

Example Queries and Gesture-Based Interactions with 3D Models

FIG. 4A depicts scenario 400 of displaying a 3D model obtained in response to a 3D-model query, in accordance with an example embodiment. Scenario 400 begins with HMD 272 capturing image 412 of an object—in this scenario, the object is a house. HMD 272 generates 3D-model query 420 with image 412 to request delivery of a 3D model of the object depicted in image 412.

FIG. 4A shows that scenario 400 continues with HMD 272 sending 3D-model query 420 to 3D-model server 410. Upon reception of 3D-model query 420, 3D-model server 410 analyzes image 412 in 3D-model query 420 to determine that the object shown in image 412 is a house. 3D-model server 410 can then query a database of 3D models, or an equivalent data structure, to locate a 3D model of a house.

The database of 3D models can store a number of 3D models, include multiple 3D models of a same type of an object; e.g., multiple 3D models of a house. In scenario 400, in response to query from 3D-model server 410, the database of 3D models provides multiple models of a house to 3D-model server 410. In some embodiments, the database of 3D models can provide an indication of which provided 3D model or models are closest to the object based on the information provide in a 3D-model query; e.g., an indication of which 3D house model is closest to the house depicted in image 412. Generally, if 3D-model server 410 finds N models, N>1, in the database of 3D models, then 3D-model server 410 can provide M models, 1≦M≦N, as part of a response to 3D-model query. If M>1, then 3D-model server 410 may provide, in a query response, an indication of which model(s) are closest to the object. In some scenarios, search query 420 can specify a maximum value for M.

In scenario 400, 3D-model server can determine a 3D-model that is closest to the object as identified in information provided in 3D-model query 420, and provide a single closest 3D model 430 as part of query response 422. Upon reception of query response 422, HMD 272 can obtain and display 3D model 430. Scenario 400 can end when HMD 272 terminates display of 3D model 430.

FIG. 4B depicts a variation of scenario 400 with 3D model 430 displayed in an environment shown as fields of view (FOVs) 440a and 440b, in accordance with an example embodiment. In the variation of scenario 400 shown in FIG. 4B, 3D model 430 is initially displayed within display 442 generated by HMD 272 while a wearer of HMD 272 observes an environment depicted by FOV 440a. A left edge of display 442 is shown having a horizontal distance D1 from a left edge of FOV 440a and a top edge of display 442 is shown having a vertical distance D2 from a top edge of FOV 440a. With respect to an environment viewed by FOV 440a, display 442 of 3D model 430 is shown in FIG. 4B roughly centered above pond 452 and somewhat to the right of tree 450.

The variation of scenario 400 depicted in FIG. 4B continues with a wearer of HMD 272 moving their focus leftward; e.g., turning the head and/or eyes of the wearer leftward to look upon the environment as depicted in FIG. 4B as FOV 440b. FIG. 4B shows that 3D model 430 is shown in display 442 within FOV 440b. As in FOV 440a of FIG. 4B, the left edge of display 442 has horizontal distance D1 from a left edge of FOV 440b and the top edge of display 442 has vertical distance D2 from a top edge of FOV 440b. That is, FIG. 4B shows that 3D model 430 and display 442 remain in a constant position relative to the FOV after the FOV changes from FOV 440a to FOV 440b. FIG. 4B also shows that 3D model 430 and display 442 change position relative to the environment after the FOV changes; e.g., display 442 is no longer centered over pond 450 and has moved close to a top of tree 450.

FIG. 4C depicts another variation of scenario 400 with 3D model 430 displayed in an environment shown as FOVs 440a and 440b, in accordance with an example embodiment.

In the variation of scenario 400 shown in FIG. 4C, 3D model 430 is initially displayed by HMD 272 while a wearer of HMD 272 observes an environment depicted by FOV 440a. A left edge of 3D model 430 is shown having a horizontal distance D3 from tree 450 and a top edge of 3D model 430 is shown having vertical distance D4 from a rightmost edge of pond 452. With respect to FOV 440a, 3D model 430 is shown in FIG. 4C roughly centered and near the bottom of the field of view.

The variation of scenario 400 depicted in FIG. 4C continues with a wearer of HMD 272 moving their focus leftward; e.g., turning the head and/or eyes of the wearer leftward to look upon the environment as depicted in FIG. 4C as FOV 440b. As in FOV 440a of FIG. 4C, the left edge of 3D model 430 is shown having a horizontal distance D3 from tree 450 and a top edge of 3D model 430 is shown having vertical distance D4 from a rightmost edge of pond 452. That is, FIG. 4C shows that 3D model 430 remains in a constant position relative to the environment after the FOV changes. FIG. 4C also shows that 3D model 430 changes position relative to the FOV after the FOV changes; e.g., 3D model 430 is no longer roughly centered within the FOV, but has moved to near to a right edge of the FOV depicted as FOV 440b.

FIGS. 5A and 5B are charts of images captured over time with corresponding motions and gestures, in accordance with an example embodiment. Near the top of FIG. 5A, an example set of three-dimensional axes is shown that indicates positive and negative directions in each axis.

Below the example set of axes, FIG. 5A shows, arranged in columns, seven example sets of input images, corresponding motions, and related gestures. FIG. 5B shows, arranged in columns similar to FIG. 5A, seven additional example sets of input images, corresponding motions, and related gestures.

The images shown in FIGS. 5A and 5B can be captured by HMD 272, or some other device. For example, the input images can be single images captured in succession during a video stream; e.g., using HMD 272 equipped with a video camera. As another example, each image can be a still image captured successively over time; e.g., using HMD 272 equipped with a still camera. Other techniques and/or devices for capturing sequences of images over time, such as the images shown in FIGS. 5A and 5B, are possible as well.

Each image shown in FIGS. 5A and 5B depicts movements of hands of a person related to HMD 272, such as the wearer of HMD 272. For example, the leftmost column of FIG. 5A shows example image 510a capturing a hand of a wearer to the left and roughly vertically centered within the image. Image 510a is followed in time by images 510b and 510c, as indicated by the Time arrow on the left side of FIG. 5A. Image 510b shows the hand shown in image 510a after the hand moves to the right, and image 510c shows the hand after moving to the right of the hand position shown in image 510b.

One or more hand positions can be determined for each image of a hand; e.g., at the center of the hand, at a position of one or more fingers of the hand, at a corner of a bounding box around the hand. The hand positions of hands in images 510a, 510b, and 510c can be placed on a grid, such as a 5×5 grid shown in FIG. 5A overlaying images 510a, 510b, and 510c, another sized grid, or as pixel positions in a grid of pixels that make up an image. In this example, the hand positions are at a grid cell of row 3, column 2 or (3, 2) for image 510a, at a grid cell of (3, 3) for image 510b, and at a grid cell of (3, 4) for image 510b. The net movement of the hand then is to move two grid cells to the right, which can be shown as motion 512 in the +X direction. A hand movement in the +X direction can be classified as a gesture to the right; e.g., right gesture 514.

The use of an overlaid grid can be used to determine general movements of hands for gestures. By translating the motions of hands to integer-valued grid cell coordinates, and then determining motions based on coordinates, slight variations in movement (e.g., a slight downward or upward movement for right gesture 514) can be filtered out. The size of the grid can be adapted as needed based on an amount of filtering of gestures. For example, the 5×5 grid shown in FIG. 5A filters hand positions into 25 grid cells, which is more filtering than may be provided by a finer grid, such as a 10×10 grid or a grid indicated by a two-dimensional array of pixels that forms an image. The additional grid cells of a finer grid can be used in circumstances where a more accurate determination of hand position is indicated; e.g., using a 10×10 grid locates hands with twice the accuracy in both horizontal and vertical dimensions than a 5×5 grid.

The sizes of motions can be determined relative to grid cells as well; e.g., a motion of two net grid cells can be considered to be smaller than a movement of three net grid cells and larger than a movement of one net grid cell. Then, the size of a motion can indicate an amount for a command based on the gesture. For example, as discussed above, right motion 514 involves a net movement of two grid cells. Then, a command based on right gesture 514; e.g., move a 3D model right, can indicate an amount of movement based on the net movement of grid cells; e.g., an amount of 2 in this example, or a relative movement of grid cells; e.g., an amount of 40% of the grid in this example.

If a hand position remains in a same hand position for multiple images, then the hand position can be considered to in a stationary hand position. Stationary hand positions can mark beginnings and ends of gestures. For example, if a hand starts with hand position (x1, y1), stays in at hand position (x1, y1) for two or more images, moves to hand position (x2, y2), and stays in hand position (x2, y2) for two or more images, where (x1, y1) and (x2, y2) each indicate a hand location as a grid cell, pixel, or by some other indicator. Then, the gesture can be determined based on a motion from hand position (x1, y1) to hand position (x2, y2).

Another technique to determine a beginning or end of a gesture is to determine a first or last image related to the gesture that includes depiction of a hand involved in making the gesture. For example, suppose five images, I1, I2, I3, I4, and I5, are captured over time with I1 captured first, I2 captured second, and so on until I5 is captured. In one example, Image I1 does not depict a hand, I2 includes a hand at hand position (x3, y3), I3 shows the hand at hand position (x4, y4), and I4 and I5 each show the hand at hand position (x5, y5). In this example, the gesture can be determined based on a motion from hand position (x3, y3) to hand position (x5, y5), as the hand originally appeared in image I2 at (x3, y3) and stayed at (x5, y5) for at least two images (I4 and I5).

In another example, Image I1 shows a hand for the first time at hand position (x6, y6), I2 shows a hand at hand position (x7, y7), I3 shows the hand at hand position (x8, y8), and I4 and I5 each do not depict a hand. In this example, the gesture can be determined based on a motion from hand position (x6, y6) to hand position (x8, y8), as the hand originally appeared in I1 at (x6, y7) and was last captured in I3 at (x8, y8). Other grids, hand position indications, movement sizes, and techniques for determining gestures from input images are possible as well.

The second-leftmost column of FIG. 5A shows images 516a, 516b, and 516c related to motion 518 in the −X dimension and to left gesture 520. This relationship can be determined using the above-mentioned techniques regarding images 510a-510c, motion 512, and right gesture 514; e.g., a grid can be overlaid on images 516a-516c, a net motion can be determined with respect to grid cells that corresponds to motion 518, and motion 518 in the −X dimension can be related to left gesture 520. The third through sixth columns of FIG. 5A show respective images, gestures, and motions for up gesture 526 in the +Y dimension shown by motion 524, down gesture 532 in the −Y dimension shown by motion 530, out gesture 538 in the +Z dimension (away from a camera or other image capture device) indicated by motion 536, and in gesture 544 in the −Z dimension (toward the camera) indicated by motion 542.

The rightmost column of FIG. 5A shows a hand position at roughly a 9 o'clock position relative to a clock in image 546a, at roughly 12 o'clock in image 546b, at roughly 3 o'clock in image 546c, and at roughly 6 o'clock in image 546d. Thus, the hand positions in images 546a-546d trace a clockwise (CW) motion, shown as clockwise motion 548. Clockwise motion 548 can then be related to clockwise gesture 550.

The leftmost column of FIG. 5B shows a hand position at roughly a 9 o'clock position relative to a clock in image 552a, at roughly 6 o'clock in image 552b, at roughly 3 o'clock in image 552c, and at roughly 12 o'clock in image 552d. Thus, the hand positions in images 552a-552d trace a clockwise (CCW) motion, shown as counterclockwise motion 554. Counterclockwise motion 554 can then be related to clockwise gesture 556.

The second and third leftmost columns of FIG. 5B show example gestures related to multiple hand positions per hand. For example, in image 558a, an index finger and a thumb of the imaged hand are shown relatively far apart. In image 558b, the index finger and thumb are closer together than shown in image 558a, and in image 558c, the index finger and thumb are shown in contact. If the positions of the thumb and the index finger are considered two hand positions, then motions of the thumb and index finger as indicated in images 558a, 558b, 558c are coming together as shown as thumb/finger motion 560. Thumb/finger motion 560 can be classified as pinch gesture 562, as the index finger and thumb motion indicates a pinching movement.

The reverse of the pinch gesture 562, e.g., from index finger and thumb initially being in contact to index finger and thumb being relatively far apart, is shown in images 564a, 564b, and 564c. If the positions of the thumb and the index finger are considered two hand positions, then motions of the thumb and index finger as indicated in images 564a, 564b, and 564 are moving apart as shown as thumb/finger motion 566. Thumb/finger motion 566 can be classified as spread gesture 568, as the index finger and thumb motion are spreading away from each other.

The fourth through seventh-leftmost columns of FIG. 5B; i.e., the four rightmost columns, show gestures made using two hands. Images 570a, 570b, and 570c show two hands coming together as indicated in left hand/right hand motion 572, in a fashion similar to the motions made by the index finger and thumb captured in images 558a-558c. As such, left hand/right hand motion 572 can be determined to be pinch gesture 562. Images 576a, 576b, and 576c show two hands moving apart as indicated in left hand/right hand motion 578, in a fashion similar to the motions made by the index finger and thumb captured in images 564a-564c. As such, left hand/right hand motion 578 can be determined to be spread gesture 578.

Images 582a, 582b, and 582c show two hands moving along a horizontal line and eventually touching. This motion, shown in FIG. 5B as left hand/right hand motion 584, can indicate closing; e.g., like curtains at a theater being closed at the end of a show or an act. As such, left hand/right hand motion 584 can be interpreted as close gesture 586. Conversely, images 588a, 582b, and 582c show two hands starting in contact and moving apart along a horizontal line. This motion, shown in FIG. 5B as left hand/right hand motion 590, can indicate opening; e.g., like curtains at a theater being opened at the beginning of a show or act. Thus, left hand/right hand motion 590 can be interpreted as open gesture 592.

FIG. 6 shows input gestures and corresponding changes to a 3D model, in accordance with an example embodiment. As indicated at the top of FIG. 6 as “Initial Conditions”, 3D-model display 610 of HMD 272 is initially displaying a view of 3D model 430. The portion of 3D model 430 visible in 3D-model display 610 is shown in FIG. 6 using a rectangle. For example, in the “Initial Conditions” portion of FIG. 6, 3D-model display 610 is shown generally centered over 3D model 430.

FIG. 6 shows three pairs of columns below the Initial Conditions portion. Each pair of columns includes a “Gesture” column indicating a gesture input to HMD 272 and a “Resulting Display” column showing an effect of the gesture input on 3D-model display 630.

At the top of the leftmost pair of columns in FIG. 6, right gesture 514 is indicated as input to HMD 272, and in response, resulting display 610a shows that the view of 3D model 430 has been shifted left which corresponds to a rightward movement of 3D model 430 as commanded by right gesture 514. That is, right gesture 514 can correspond to; i.e., lead to generation of, a command to HMD 272 to shift the view shown in 3D-model display 610 left and/or move 3D model 430 right. Similarly, the other input gestures discussed at least in the context of FIG. 6, when input to HMD 272 can correspond to one or more commands to HMD 272 to change the view shown in 3D-model display 610 and/or 3D model 430 as indicated as discussed in the context of each respective input gesture.

The second-from-top row in the leftmost pair of columns shows left gesture 520 indicated as input to HMD 272, and in response, resulting display 610b shows that the view of 3D model 430 has been shifted right which corresponds to a leftward movement of 3D model 430 as commanded by left gesture 514.

The third-from-top row in the leftmost pair of columns shows up gesture 526 indicated as input to HMD 272. In response, HMD 272 generates resulting display 610c showing that the view of 3D model 430 has been moved down corresponding to commanded upward movement of the 3D model. The fourth-from-top rows in the leftmost pair of columns shows down gesture 532 indicated as input to HMD 272. In response, HMD 272 generates resulting display 610d with the view of 3D model 430 having been moved upward, corresponding to a commanded downward movement of the 3D model.

The bottom row in the leftmost pair of columns and the five rows in the center pair of columns of FIG. 6 show example input gestures related to commanded rotations of 3D model 430. When a left gesture is (immediately) followed by a right gesture, HMD 272 can interpret that pair of gestures as one left-then-right gesture 620. HMD 272 can interpret left-then-right gesture 620 as an edge-on view of a gesture representing a circle rotating about the Y axis in a clockwise direction; in response, HMD 272 can generate resulting display 610e showing a view of 3D model 430 rotated clockwise about its Y axis. Similarly, HMD 272 can interpret a right gesture (immediately) followed by a left gesture as right-then-left gesture 622; in response, HMD 272 can generate resulting display 610f showing a view of 3D model 430 rotated counterclockwise about its Y axis.

When an up gesture is (immediately) followed by a down gesture, HMD 272 can interpret that pair of gestures as one up-then-down gesture 630. HMD 272 can interpret up-then-down gesture 630 as an edge-on view of a gesture representing a circle rotating about the X axis in a counterclockwise direction; in response, HMD 272 can generate resulting display 610g showing 3D model 430 rotated clockwise about its X axis. Similarly HMD 272 can interpret a down gesture (immediately) followed by an up gesture as one down-then-up gesture 632 and can generate resulting display 610h showing a view of 3D model 430 rotated counterclockwise about its X axis.

HMD 272 can interpret clockwise gesture 550 as a command to rotate 3D model 430 clockwise about its Z axis and generate resulting display 610i showing a view of 3D model 430 rotated in a clockwise direction about its Z axis. Additionally, HMD 272 can interpret counterclockwise gesture 550 as a command to rotate 3D model 430 counterclockwise about its Z axis and generate resulting display 610j showing 3D model 430 rotated in a counterclockwise direction about its Z axis.

In some cases, two or more different gestures can have identical effects on a resulting display. For example, performing either in gesture 544 or spread gesture 568 can be interpreted as a command for zooming in, enlarging, moving 3D model 430 closer to the display, and/or moving 3D model 430 in the −Z direction. In response to either in gesture 544 or spread gesture 568, HMD 272 can generate an enlarged view of 3D model 430 as indicated using resulting display 610k, shown in the top row of the rightmost pair of columns in FIG. 6. As another example, performing either out gesture 538 or pinch gesture 562 can be interpreted as a command for zooming out, shrinking, moving 3D model 430 away from the display, and/or moving 3D model 430 in the +Z direction. In response to either out gesture 538 or pinch gesture 562, HMD 272 can generate a smaller view of 3D model 430 as indicated using resulting display 610m, shown in the second-from-top row of the rightmost pair of columns in FIG. 6.

The middle row of the rightmost pair of columns in FIG. 6 shows that close gesture 586 can correspond to commanding HMD 272 to terminate display a view of 3D model 430. The second-from-bottom (fourth-from-top) middle row of the rightmost pair of columns in FIG. 6 shows that open gesture 586 can correspond to commanding HMD 272 to launch a query for a new model using query display 640. In some embodiments, one or more gestures, such as close gesture 586, received as input while HMD 272 is displaying query display 640 can be interpreted as closing query display 640 and perhaps reverting to the previous display; e.g., display 610 shown as part of the initial conditions.

The gestures discussed in the context of FIGS. 5A, 5B, and 6 can be combined. For example, to rotate a 3D model on its X axis and then on its Y axis, a first gesture, such as an up-then-down gesture or a down-then-up gesture, can be received to rotate the 3D model on the X axis and then a second gesture, such as a left-then-right gesture or right-then-left gesture, can be received to rotate the 3D model on the Y axis.

In some embodiments, other gestures 650 can be input to HMD 272. For example, a diagonal line gesture can be input to HMD 272 corresponding to a combination of either a left or a right gesture and either an up or a down gesture. For example, a gesture with an initial hand position at or near an upper-left-hand corner of an image and ending with a hand position at or near a lower-right-hand corner of a subsequent image can be interpreted as a combination of a right gesture and a down gesture, and so translate a view of 3D model 430 rightwards and downwards in 3D model display 610.

Other gestures 650 can include gestures that interact with the object modeled by 3D model 430. For example, a gesture to touch the object modeled by 3D model 430 can lead to HMD 272 providing additional information about part of or the entire object, such as name, model number, identification number, size, weight, material(s) used to make the object, component information, cost/price/delivery information, other information, and combinations thereof.

As another example, other gestures 650 can include gestures to touch virtual buttons or other control elements that control 3D-model display 630. For example, a sequence of gestures to touch a virtual “color” button, to touch a blue color on a color-palette control, and to touch 3D model 430 can change the color of 3D model 430 to a blue color. A later sequence of gestures to touch a beige color on the color-palette control and to touch 3D model 430 can change the color of 3D model 430 from blue to beige.

Other interpretations can be used as well for gestures shown in FIG. 6, perhaps in the context of touching part or all of the object. For example, open gesture 592 made while both hands are touching the object (but perhaps not in contact with each other) can be interpreted as a gesture to split the object into components. As another example, close gesture 586 begun with each hand on a separate component of the object (or two separate objects) can be interpreted as a gesture to combine the components of the object (or the two separate objects) into one object.

Other gestures 650 can include gestures to perform other operations on 3D model 430 than already discussed in the context of FIGS. 5A, 5B, and 6. These other operations can include, but are not limited to, skew operations, move within or outside of 3D model 430, store 3D model 430, undo or redo a change to 3D model 430, add an additional model to display 610 (e.g., add landscaping-related model(s) to the house modeled as 3D model 430), remove model(s) from display 610, operations that involve sub-operations discussed in the context of previously-discussed gestures, and combinations thereof.

Once all gestures are identified for interacting with the object/3D model, then gestures not identified for object/3D model interaction can be ignored or otherwise processed. For example, a gesture to touch or point at something other than the object/3D model can be interpreted as a gesture unrelated to the object. Gestures determined to be unrelated to the object/3D model can be ignored, prompted (e.g., “Did you mean to interact with the 3D model? If so, please repeat your gesture.”), or otherwise processed.

As an example of prompting for gestures, suppose a new gesture, such as a two-handed leftward movement, is performed by a wearer of HMD 272. Then, after determining the new gesture is unrecognized, HMD 272 can access a define/redefine gesture function to create and/or change mappings between gestures and operations. HMD 272 can provide a prompt to the wearer to inform the wearer about the new gesture being an unrecognized gesture. HMD 272 can request the wearer then either indicate which operation(s) be performed in response to the unrecognized gesture or if the unrecognized gesture should be ignored. In this example, in response to being prompted about the unrecognized two-handed leftward movement, the wearer can indicate that, that two (or more) “left” model view changes are to be made in succession; i.e., two-handed leftward gestures can now act as a “fast forward left” motion. After receiving the indication from the wearer, HMD 272 can use the define/redefine gesture function to associate two-handed leftward movements with two (or more) left model view changes.

The define/redefine gesture function can be used to redefine operations that occur in response to gestures shown in FIG. 6; e.g., a wearer that would like to reverse the left and right gestures can access the define/redefine gesture function. Then, HMD 272 can prompt the wearer to make a gesture, such as the left gesture, perhaps identify the gesture, and then prompt the wearer to select one or more operations to perform in response to the gestures; e.g., a rightward model movement. After receiving the inputs about the left gesture to be redefined and the operation(s) to be performed for the redefined left gesture, HMD 272 can use the define/redefine gesture function to change the mapping of the left gesture so to make a rightward model movement. A similar procedure can then be used by the wearer to change the mapping of the right gesture to a leftward model movement. Many other examples of input gestures and corresponding commands to HMD 272 are possible as well.

Example Data Network

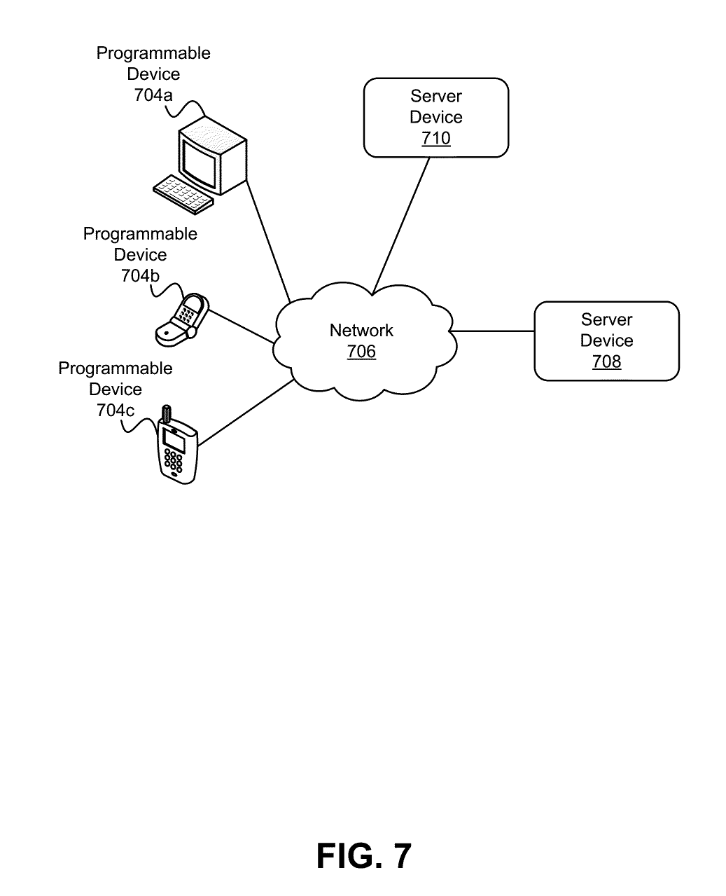

FIG. 7 shows server devices 708, 710 configured to communicate, via network 706, with programmable devices 704a, 704b, and 704c. Network 706 may correspond to a LAN, a wide area network (WAN), a corporate intranet, the public Internet, or any other type of network configured to provide a communications path between networked computing devices. The network 706 may also correspond to a combination of one or more LANs, WANs, corporate intranets, and/or the public Internet. One or more of server devices 708, 710, network 706, and programmable devices 704a, 704b, and 704c can be configured to perform part or all of method 100 and/or some or all of the herein-described functionality of HMD 272 and/or 3D-model server 410.

Although FIG. 7 only shows three programmable devices, distributed application architectures may serve tens, hundreds, or thousands of programmable devices. Moreover, programmable devices 704a, 704b, and 704c (or any additional programmable devices) may be any sort of computing device, such as an ordinary laptop computer, desktop computer, network terminal, wireless communication device (e.g., a cell phone or smart phone), and so on. In some embodiments, programmable devices 704a, 704b, and 704c may be dedicated to the design and use of software applications. In other embodiments, programmable devices 704a, 704b, and 704c may be general purpose computers that are configured to perform a number of tasks and need not be dedicated to software development tools. In still other embodiments, programmable devices 704a, 704b, and/or 704c can be configured to perform some or all of the herein-described functionality of a computing device.

Server devices 708, 710 can be configured to perform one or more services, as requested by programmable devices 704a, 704b, and/or 704c. For example, server device 708 and/or 710 can provide content to programmable devices 704a-704c. The content can include, but is not limited to, web pages, hypertext, scripts, binary data such as compiled software, images, audio, and/or video. The content can include compressed and/or uncompressed content. The content can be encrypted and/or unencrypted. Other types of content are possible as well.

As another example, server device 708 and/or 710 can provide programmable devices 704a-704c with access to software for database, search, computation, graphical, audio, video, World Wide Web/Internet utilization, and/or other functions. Many other examples of server devices are possible as well.

Computing Device Architecture

FIG. 8A is a block diagram of a computing device (e.g., system) in accordance with an example embodiment. In particular, computing device 800 shown in FIG. 8A can be configured to perform part or all of method 100 and/or some or all of the herein-described functionality of HMD 272, 3D-model server 410, one or more functions of server devices 708, 710, network 706, and/or one or more of programmable devices 704a, 704b, and 704c. Computing device 800 may include a user interface module 801, a network-communication interface module 802, one or more processors 803, and data storage 804, all of which may be linked together via a system bus, network, or other connection mechanism 805.

User interface module 801 can be operable to send data to and/or receive data from external user input/output devices. For example, user interface module 801 can be configured to send and/or receive data to and/or from user input devices such as a keyboard, a keypad, a touch screen, a computer mouse, a track ball, a joystick, a camera, a voice recognition module, and/or other similar devices. User interface module 801 can also be configured to provide output to user display devices, such as one or more cathode ray tubes (CRT), liquid crystal displays (LCDs), light emitting diodes (LEDs), displays using digital light processing (DLP) technology, printers, light bulbs, and/or other similar devices, either now known or later developed. User interface module 801 can also be configured to generate audible output(s), such as a speaker, speaker jack, audio output port, audio output device, earphones, and/or other similar devices.

Network-communications interface module 802 can include one or more wireless interfaces 807 and/or one or more wireline interfaces 808 that are configurable to communicate via a network, such as network 706 shown in FIG. 7. Wireless interfaces 807 can include one or more wireless transmitters, receivers, and/or transceivers, such as a Bluetooth transceiver, a Zigbee transceiver, a Wi-Fi transceiver, a WiMAX transceiver, and/or other similar type of wireless transceiver configurable to communicate via a wireless network. Wireline interfaces 808 can include one or more wireline transmitters, receivers, and/or transceivers, such as an Ethernet transceiver, a Universal Serial Bus (USB) transceiver, or similar transceiver configurable to communicate via a twisted pair wire, a coaxial cable, a fiber-optic link, or a similar physical connection to a wireline network.

In some embodiments, network communications interface module 802 can be configured to provide reliable, secured, and/or authenticated communications. For each communication described herein, information for ensuring reliable communications (i.e., guaranteed message delivery) can be provided, perhaps as part of a message header and/or footer (e.g., packet/message sequencing information, encapsulation header(s) and/or footer(s), size/time information, and transmission verification information such as CRC and/or parity check values). Communications can be made secure (e.g., be encoded or encrypted) and/or decrypted/decoded using one or more cryptographic protocols and/or algorithms, such as, but not limited to, DES, AES, RSA, Diffie-Hellman, and DSA. Other cryptographic protocols and/or algorithms can be used as well or in addition to those listed herein to secure (and then decrypt/decode) communications.

Processors 803 can include one or more general purpose processors and/or one or more special purpose processors (e.g., digital signal processors, application specific integrated circuits, etc.). Processors 803 can be configured to execute computer-readable program instructions 806 that are contained in the data storage 804 and/or other instructions as described herein. In some embodiments, data storage 804 can additionally include storage required to perform at least part of the herein-described methods and techniques and/or at least part of the functionality of the herein-described devices and networks.

Data storage 804 can include one or more computer-readable storage media that can be read and/or accessed by at least one of processors 803. For example, data storage 804 can provide memory for the herein-described instructions; e.g., instructions 310, and/or lighting data storage; e.g., lighting data storage 320. The one or more computer-readable storage media can include volatile and/or non-volatile storage components, such as optical, magnetic, organic or other memory or disc storage, which can be integrated in whole or in part with at least one of processors 803. In some embodiments, data storage 804 can be implemented using a single physical device (e.g., one optical, magnetic, organic or other memory or disc storage unit), while in other embodiments, data storage 804 can be implemented using two or more physical devices.

Cloud-Based Servers

FIG. 8B depicts a network 606 of computing clusters 809a, 809b, 809c arranged as a cloud-based server system in accordance with an example embodiment. Server devices 608 and/or 610 can be cloud-based devices that store program logic and/or data of cloud-based applications and/or services. In some embodiments, server devices 608 and/or 610 can be a single computing device residing in a single computing center. In other embodiments, server device 608 and/or 610 can include multiple computing devices in a single computing center, or even multiple computing devices located in multiple computing centers located in diverse geographic locations. For example, FIG. 6 depicts each of server devices 608 and 610 residing in different physical locations.

In some embodiments, data and services at server devices 608 and/or 610 can be encoded as computer readable information stored in non-transitory, tangible computer readable media (or computer readable storage media) and accessible by programmable devices 604a, 604b, and 604c, and/or other computing devices. In some embodiments, data at server device 608 and/or 610 can be stored on a single disk drive or other tangible storage media, or can be implemented on multiple disk drives or other tangible storage media located at one or more diverse geographic locations.

FIG. 8B depicts a cloud-based server system in accordance with an example embodiment. In FIG. 8B, the functions of server device 608 and/or 610 can be distributed among three computing clusters 809a, 809b, and 809c. Computing cluster 809a can include one or more computing devices 800a, cluster storage arrays 810a, and cluster routers 811a connected by a local cluster network 812a. Similarly, computing cluster 809b can include one or more computing devices 800b, cluster storage arrays 810b, and cluster routers 811b connected by a local cluster network 812b. Likewise, computing cluster 809c can include one or more computing devices 800c, cluster storage arrays 810c, and cluster routers 811c connected by a local cluster network 812c.

In some embodiments, each of the computing clusters 809a, 809b, and 809c can have an equal number of computing devices, an equal number of cluster storage arrays, and an equal number of cluster routers. In other embodiments, however, each computing cluster can have different numbers of computing devices, different numbers of cluster storage arrays, and different numbers of cluster routers. The number of computing devices, cluster storage arrays, and cluster routers in each computing cluster can depend on the computing task or tasks assigned to each computing cluster.

In computing cluster 809a, for example, computing devices 800a can be configured to perform various computing tasks of electronic communications server 812. In one embodiment, the various functionalities of electronic communications server 812 can be distributed among one or more of computing devices 800a, 800b, and 800c. Computing devices 800b and 800c in computing clusters 809b and 809c can be configured similarly to computing devices 800a in computing cluster 809a. On the other hand, in some embodiments, computing devices 800a, 800b, and 800c can be configured to perform different functions.

In some embodiments, computing tasks and stored data associated with server devices 608 and/or 610 can be distributed across computing devices 800a, 800b, and 800c based at least in part on the processing requirements of server devices 608 and/or 610, the processing capabilities of computing devices 800a, 800b, and 800c, the latency of the network links between the computing devices in each computing cluster and between the computing clusters themselves, and/or other factors that can contribute to the cost, speed, fault-tolerance, resiliency, efficiency, and/or other design goals of the overall system architecture.

The cluster storage arrays 810a, 810b, and 810c of the computing clusters 809a, 809b, and 809c can be data storage arrays that include disk array controllers configured to manage read and write access to groups of hard disk drives. The disk array controllers, alone or in conjunction with their respective computing devices, can also be configured to manage backup or redundant copies of the data stored in the cluster storage arrays to protect against disk drive or other cluster storage array failures and/or network failures that prevent one or more computing devices from accessing one or more cluster storage arrays.

Similar to the manner in which the functions of server devices 608 and/or 610 can be distributed across computing devices 800a, 800b, and 800c of computing clusters 809a, 809b, and 809c, various active portions and/or backup portions of these components can be distributed across cluster storage arrays 810a, 810b, and 810c. For example, some cluster storage arrays can be configured to store the data of server device 608, while other cluster storage arrays can store data of server device 610. Additionally, some cluster storage arrays can be configured to store backup versions of data stored in other cluster storage arrays.

The cluster routers 811a, 811b, and 811c in computing clusters 809a, 809b, and 809c can include networking equipment configured to provide internal and external communications for the computing clusters. For example, the cluster routers 811a in computing cluster 809a can include one or more internet switching and routing devices configured to provide (i) local area network communications between the computing devices 800a and the cluster storage arrays 801a via the local cluster network 812a, and (ii) wide area network communications between the computing cluster 809a and the computing clusters 809b and 809c via the wide area network connection 813a to network 606. Cluster routers 811b and 811c can include network equipment similar to the cluster routers 811a, and cluster routers 811b and 811c can perform similar networking functions for computing clusters 809b and 809b that cluster routers 811a perform for computing cluster 809a.

In some embodiments, the configuration of the cluster routers 811a, 811b, and 811c can be based at least in part on the data communication requirements of the computing devices and cluster storage arrays, the data communications capabilities of the network equipment in the cluster routers 811a, 811b, and 811c, the latency and throughput of local networks 812a, 812b, 812c, the latency, throughput, and cost of wide area network links 813a, 813b, and 813c, and/or other factors that can contribute to the cost, speed, fault-tolerance, resiliency, efficiency and/or other design goals of the moderation system architecture.

Example methods and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features.

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. In the figures, similar symbols typically identify similar components, unless context dictates otherwise. The illustrative embodiments described in the detailed description, figures, and claims are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

It should be understood that other embodiments can include more or less of each element shown in a given figure. Further, some of the illustrated elements can be combined or omitted. Yet further, an example embodiment can include elements that are not illustrated in the figures.

With respect to any or all of the ladder diagrams, scenarios, and flow charts in the figures and as discussed herein, each block and/or communication may represent a processing of information and/or a transmission of information in accordance with example embodiments. Alternative embodiments are included within the scope of these example embodiments. In these alternative embodiments, for example, functions described as blocks, transmissions, communications, requests, responses, and/or messages may be executed out of order from that shown or discussed, including substantially concurrent or in reverse order, depending on the functionality involved. Further, more or fewer blocks and/or functions may be used with any of the ladder diagrams, scenarios, and flow charts discussed herein, and these ladder diagrams, scenarios, and flow charts may be combined with one another, in part or in whole.

Moreover, a block that represents one or more information transmissions may correspond to information transmissions between software and/or hardware modules in the same physical device. However, other information transmissions may be between software modules and/or hardware modules in different physical devices.

A block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical functions or actions in the method or technique. The program code and/or related data may be stored on any type of computer readable medium such as a storage device including a disk or hard drive or other storage medium.

The computer readable medium may also include non-transitory computer readable media such as computer-readable media that stores data for short periods of time like register memory, processor cache, and random access memory (RAM). The computer readable media may also include non-transitory computer readable media that stores program code and/or data for longer periods of time, such as secondary or persistent long term storage, like read only memory (ROM), optical or magnetic disks, compact-disc read only memory (CD-ROM), for example. The computer readable media may also be any other volatile or non-volatile storage systems. A computer readable medium may be considered a computer readable storage medium, for example, and/or a tangible storage device.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. A method, comprising:
receiving a 3D model for an object at a head-mountable display (HMD), wherein the 3D model comprises three-dimensional shape and texture information about the object, the three-dimensional shape and texture information about the object specified with respect to at least a first axis, a second axis, and a third axis, wherein each of the first axis, the second axis, and the third axis differs;
displaying a view of the 3D model using the HMD;
receiving an input gesture at the HMD;
determining whether the input gesture comprises a 3D-model gesture of a plurality of 3D-model gestures, wherein the plurality of 3D-model gestures comprise a first 3D-model gesture to modify display of the 3D model with respect to the first axis, a second 3D-model gesture to modify display of the 3D model with respect to the second axis, and a third 3D-model gesture to modify display of the 3D model with respect to the third axis; and
after determining that the input gesture is related to the 3D model, the HMD:
updating the view of the 3D model based on the input gesture, and
displaying the updated view of the 3D model.

2. The method of claim 1, wherein the input gesture comprises a gesture to rotate the 3D model.

3. The method of claim 2, wherein updating the view of the 3D model comprises:
rotating the 3D model as indicated by the gesture to rotate the 3D model; and
generating a display of the rotated 3D model.

4. The method of claim 2, wherein the gesture to rotate the 3D model comprises a first gesture to rotate the 3D model on a first axis and a second gesture to rotate the 3D model on a second axis, and wherein the first axis differs from the second axis.

5. The method of claim 1, wherein the information about the object comprises an image related to the object.

6. The method of claim 5, wherein the image related to the object is at least one image selected from the group consisting of an image that depicts at least part of the object, an image of a Quick Response (QR) code related to the object, and an image of a bar code related to the object.

7. The method of claim 1, further comprising:
receiving a second input gesture at the HMD;
determining whether the second input gesture corresponds to a close gesture; and
in response to determining that the second input gesture corresponds to the close gesture, terminating the view of the 3D model.

8. A head-mountable display (HMD), comprising:
a display;
a processor; and
a non-transitory computer readable medium, configured to store at least instructions, wherein the instructions are executable by the processor to cause the HMD to perform functions comprising:
receiving a 3D model for an object, wherein the 3D model comprises three-dimensional shape and texture information about the object, the three-dimensional shape and texture information about the object specified with respect to at least a first axis, a second axis, and a third axis, wherein each of the first axis, the second axis, and the third axis differs;
displaying a view of the 3D model using the display;
receiving an input gesture;
determining whether the input gesture comprises a 3D-model gesture of a plurality of 3D-model gestures, wherein the plurality of 3D-model gestures comprise a first 3D-model gesture to modify display of the 3D model with respect to the first axis, a second 3D-model gesture to modify display of the 3D model with respect to the second axis, and a third 3D-model gesture to modify display of the 3D model with respect to the third axis; and
after determining that the input gesture is related to the 3D model:
updating the view of the 3D model based on the input gesture, and
displaying the updated view of the 3D model using the display.

9. The HMD of claim 8, wherein the input gesture comprises a gesture to rotate the 3D model.

10. The HMD of claim 9, wherein updating the view of the 3D model comprises:
rotating the 3D model as indicated by the gesture to rotate the 3D model; and
generating a display of the rotated 3D model.

11. The HMD of claim 9, wherein the gesture to rotate the 3D model comprises a first gesture to rotate the 3D model on a first axis and a second gesture to rotate the 3D model on a second axis, and wherein the first axis differs from the second axis.

12. The HMD of claim 8, further comprising a camera, and wherein receiving the input gesture comprises:
capturing a plurality of images using the camera; and
determining the input gesture from the plurality of images.

13. The HMD of claim 8, wherein the information about the object comprises an image related to the object.

14. The HMD of claim 8, further comprising:
receiving a second input gesture;
determining whether the second input gesture corresponds to a close gesture; and
in response to determining that the second input gesture corresponds to the close gesture, terminating the view of the 3D model.

15. A non-transitory computer readable medium having stored therein instructions executable by a processor of a head-mountable display (HMD) to cause the HMD to perform functions, the functions comprising:
receiving a 3D model for an object, wherein the 3D model comprises three-dimensional shape and texture information about the object, the three-dimensional shape and texture information about the object specified with respect to at least a first axis, a second axis, and a third axis, and wherein each of the first axis, the second axis, and the third axis differs;
displaying a view of the 3D model;
receiving an input gesture;
determining whether the input gesture comprises a 3D-model gesture of a plurality of 3D-model gestures, wherein the plurality of 3D-model gestures comprise a first 3D-model gesture to modify display of the 3D model with respect to the first axis, a second 3D-model gesture to modify display of the 3D model with respect to the second axis, and a third 3D-model gesture to modify display of the 3D model with respect to the third axis; and
after determining that the input gesture is related to the 3D model:
updating the view of the 3D model based on the input gesture, and
displaying the updated view of the 3D model.

16. The non-transitory computer readable medium of claim 15, wherein the input gesture comprises a gesture to rotate the 3D model.

17. The non-transitory computer readable medium of claim 16, wherein updating the view of the 3D model comprises:
rotating the 3D model as indicated by the gesture to rotate the 3D model; and
generating a display of the rotated 3D model.

18. The non-transitory computer readable medium of claim 16, wherein the gesture to rotate the 3D model comprises a first gesture to rotate the 3D model on a first axis and a second gesture to rotate the 3D model on a second axis, and wherein the first axis differs from the second axis.

19. The non-transitory computer readable medium of claim 15, wherein the information about the object comprises an image related to the object.

20. The non-transitory computer readable medium of claim 15, further comprising:
receiving a second input gesture;
determining whether the second input gesture corresponds to a close gesture; and
in response to determining that the second input gesture corresponds to the close gesture, terminating the view of the 3D model.
